(19) United States
(12) Patent Application Publication
(10) Pub. No.: US 2010/0214660 A1
(43) Pub. Date: Aug. 26, 2010

(54) BEAM SHAPING DEVICE

(75) Inventor: Cheng-Hsi MIAO, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: AETHER SYSTEMS INC., Taipei (TW)

(21) Appl. No.: 12/482,739

(22) Filed: Jun. 11, 2009

(30) Foreign Application Priority Data
Feb. 24, 2009 (TW) 098105734

(51) Int. Cl. G02B 27/09; G02B 27/42

(52) U.S. Cl. 359/571

(57) ABSTRACT

A multi-wavelength beam shaping device is made of a plurality of first micro-steps responsive to light beams of a first specific light wavelength to effect wave diffraction, and a plurality of second micro-steps responsive to light beams of a second light wavelength to effect wave diffraction. Multi-wavelength original light beams can be shaped into a specific lighting pattern to project.

### RELATED APPLICATIONS

The present application is based on, and claims priority from, Taiwanese Application Number 098105734, filed Feb. 24, 2009, the disclosure of which is hereby incorporated by reference herein in its entirety.

### FIELD OF THE INVENTION

This invention relates to an optical beam shaping device, original light beams of multi-wavelength can be used as a light source and be shaped into a predetermined lighting pattern for projection.

### BACKGROUND

FIG. 1 shows a conventional light projection system.

A conventional light projection system is shown in FIG. 1, a photomask 13 is used for defining the lighting pattern to be projected. The photomask 13 has passing zones 14 to allow light beams to pass through. Wide angle light sources such as light emitted diodes (LED) 101, 102, 103 are mounted on a circuit board 10, give original light beams OLB. Collimating lens 12 are used for transforming the original light beams (OLB) into parallel light beams (PLB) to project on to the photomask 13. The photomask 13 has non-passing zones 141 for preventing the original light beams from passing through. A lighting pattern to be projected on a screen 55 is formed by the light beams which pass through the passing zones 14. In other words, the lighting pattern P1, P2 to be projected is exactly the same as the passing zone pattern 14 made on the photomask 13. The traditional projection system is based on particle property of light beams where the light beams propagate in a straight line. The traditional projection system does not provide much design choices. A more versatile projection system but with a structure no more complicated than a traditional projection system is desirable.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 shows a conventional light projection system.

FIG. 2A shows a first embodiment of a beam shaping device according to the present invention.

FIG. 2B shows an enlarged elevation view of an R cell of FIG. 2A.

FIG. 3 shows a section view along YY′ of the cell of FIG. 2B.

FIG. 4 shows a first projection system using the device of FIG. 3.

FIG. 5 shows a second projection system using the device of FIG. 3.

FIG. 6 shows a second embodiment of a beam shaping device according to the present invention.

FIG. 7 shows an elevation view of the projection system shown in FIG. 4.

FIG. 8 shows a second projection system using the beam shaping device according to the present invention.

FIG. 9 shows a third projection system using the beam shaping device according to the present invention.

FIG. 10 shows a frame is used to mount elements of a first embodiment the present invention.

FIG. 11 shows a frame is used to mount elements of a second embodiment the present invention.

FIG. 12 shows samples of lighting pattern to be projected.

FIG. 13 shows a third embodiment of the beam shaping device according to the present invention.

FIG. 14 shows a fourth embodiment of the beam shaping device according to the present invention.

FIG. 15A, 15B, 15C shows various types of a parallel light source.

FIG. 16 shows a fifth embodiment of the beam shaping device according to the present invention.

FIG. 17A shows a section view of the projection system of FIG. 16.

FIG. 17B shows a modified design of the projection system of FIG. 17A.

FIG. 18 shows a frame is used to mount the elements of the projection system of FIG. 17A

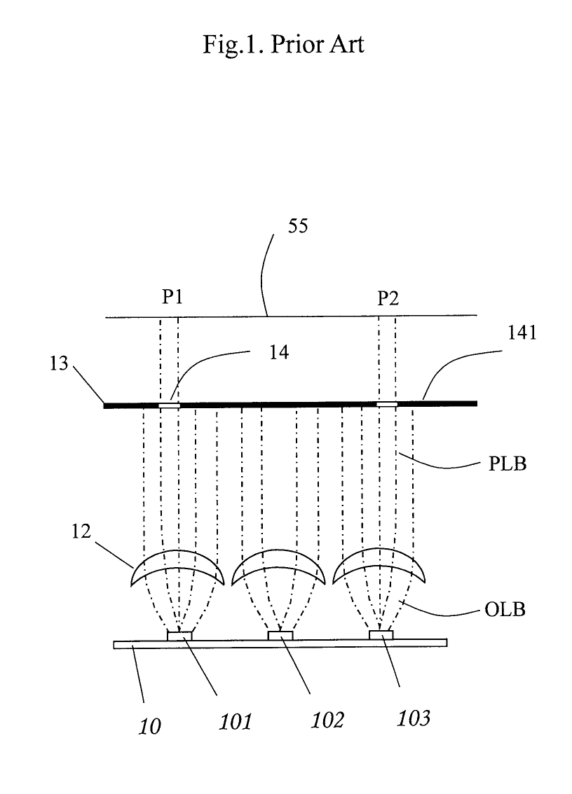

### DETAILED DESCRIPTION OF EMBODIMENTS

The beam shaping theory relied upon in this invention is based on wave property of light. Light wave diffraction is triggered by a critical part “beam shaping device” which has a plurality of micro-steps made on at least one of its two side surfaces. A pre-determined lighting pattern including but not limited to continuous zone, non-continuous zones, regular shapes, irregular shapes, points, lines, spots, or areas can be shaped through a beam shaping device as disclosed in this invention. The micro-steps to be formed on the beam shaping device are designed by computer aided design (CAD) through software simulation. Each of the micro-steps has a step height h and a step width w. The step height h relates to light beams of a specific light wavelength, and the step width w relates to a diffraction angle of light beams of the specific light wavelength. In other words, a first step height of the micro-steps responses to light beams of a first light wavelength to cause diffraction, and a first width of the micro-steps causes a first diffraction angle of light beams of the first specific light wavelength. A second step height of the micro-steps responses to light beams of a second specific light wavelength to cause diffraction, and a second step width of the micro-steps causes a second diffraction angle of light beams of the second specific light wavelength.

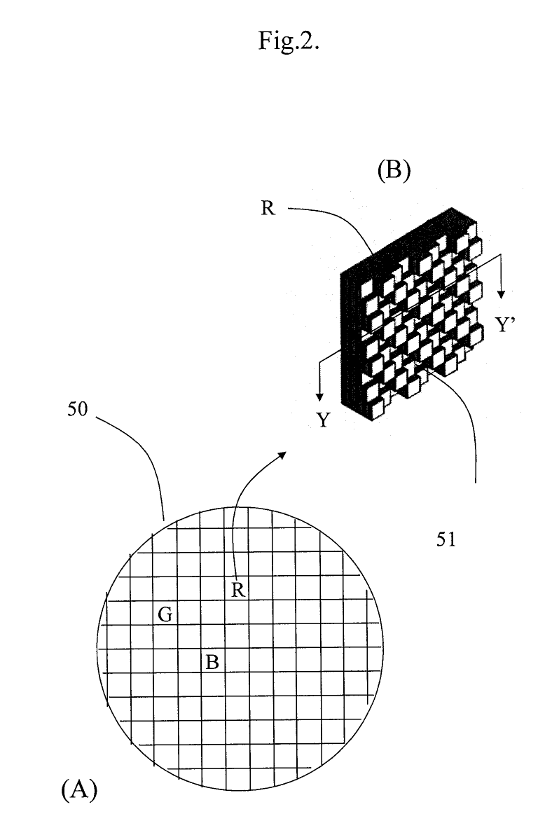

FIG. 2A shows a first embodiment of a beam shaping device according to the present invention.

A piece of multi-wavelength beam shaping device 50 is exemplified in FIG. 2A. The multi-wavelength beam shaping device 50 includes, for example, R, G, and B three different cells. Wherein an R cell represents micro-steps zone for diffracting red light beams; a G cell represents micro-steps zone for diffracting green light beams; and a B cell represents micro-steps zone for diffracting Blue light beams. An enlarged elevation view of an R cell is shown in FIG. 2B.

FIG. 2B shows an enlarged elevation view of an R cell of FIG. 2A.

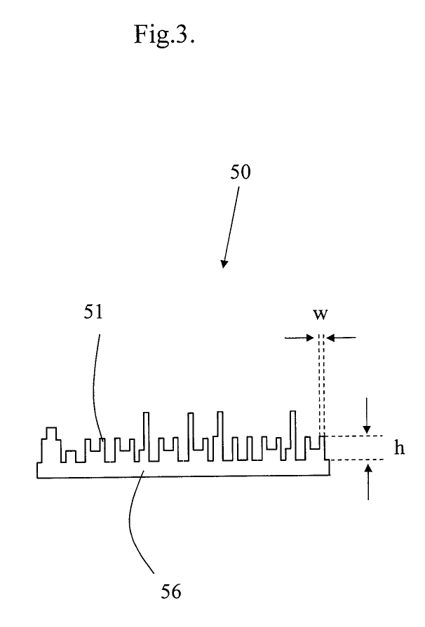

The micro-steps of an R cell of FIG. 2A is enlarged as seen in FIG. 2B, a plurality of micro-steps are made to cause diffraction of red light wavelength. The step height h and step width w of the micro-steps are designed referring to red light wavelength. There two step widths and three step heights in FIG. 3 as an example. At lease one step height and one step width is needed to finish the beam shaping device. However, more step heights and more step width shall create more subtle lighting pattern to be projected. Similarly, a G cell has a plurality of micro-steps designed to cause wave diffraction of green light beams; and a B cell has a plurality of micro-steps designed to cause wave diffraction of blue light beams.

FIG. 3 shows a section view along YY′ of the cell of FIG. 2.

A cross section view of an R cell according to line YY′ of FIG. 2 is shown in FIG. 3. A plurality of micro-steps 51 are made on top side of a substrate 56. The heights are designed to cause diffraction of a specific wavelength, for example, either red light wavelength, green light wavelength, blue light wavelength, infrared (IR) light wavelength, near infrared (NIR) light wavelength, ultraviolet (UV) light wavelength, or extreme ultraviolet (EUV) light wavelength.

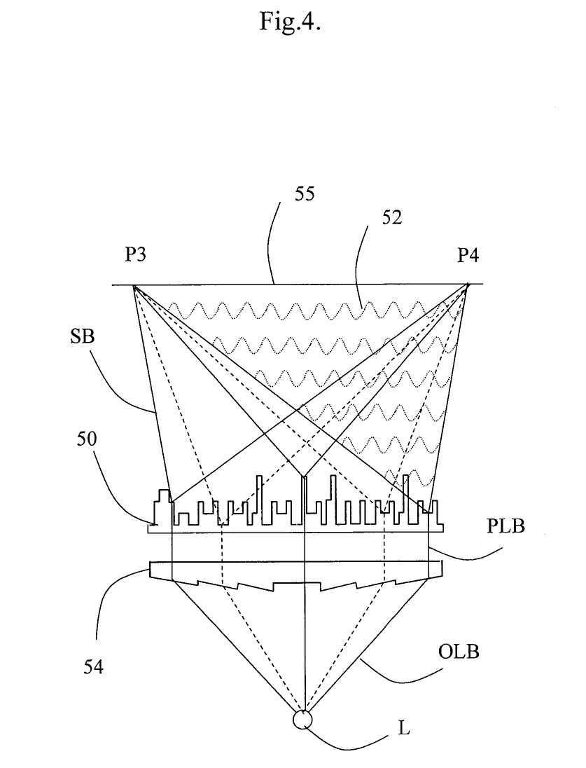

FIG. 4 shows a first projection system using the device of FIG. 3.

A first projection system using a beam shaping device is shown in FIG. 4, a wide angle light source L is used as a light source which emits original light beams OLB. The original light beams OLB include light beams of multi-wavelength. A Fresnel collimating lens 54 is used to collimate the original light beams OLB into parallel light beams PLB which are then passing through a piece of beam shaping device 50. Wave diffraction 52 occurs when parallel light beams PLB of a specific light wavelength passing through the beam shaping device 50. Shaped beams 58 are formed after wave interference of the passed light beams and then projected onto a screen 55. Points P3 and P4 are spots illuminated by the shaped beams SB, as an example in FIG. 4. The areas except points P3 and P4 on the screen 55 are dark where no light beam of the specific light wavelength reaches.

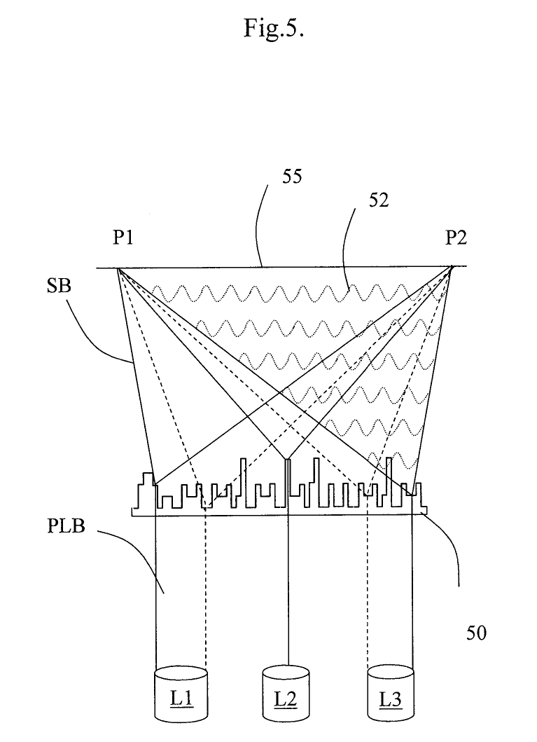

FIG. 5 shows a second projection system using the device of FIG. 3.

Parallel light sources are used in FIG. 5. Three parallel light sources L1, L2, L3, each of which emits parallel light beams PLB for passing through the beam shaping device 50. The operation theory is the same as that described in previous paragraphs.

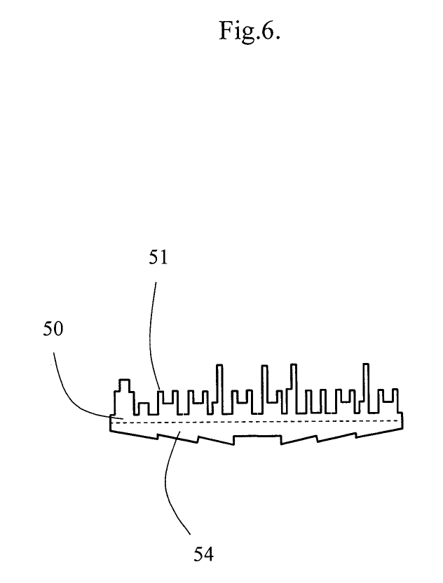

FIG. 6 shows a second embodiment of a beam shaping device according to the present invention.

The beam shaping device 50 can be integrated with the collimating lens 54 as shown in FIG. 6. The integrated device is seen that micro-steps 51 are made on top side and a Fresnel lens 54 is made on the bottom side.

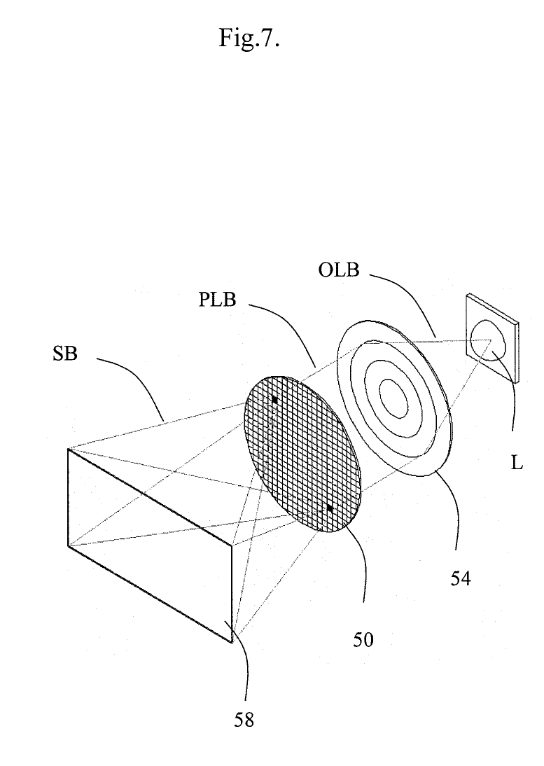

FIG. 7 shows an elevation view of the projection system shown in FIG. 4.

An elevation view of FIG. 4 is shown in FIG. 7, a wide angle light source L emits original light beams OLB, a collimating lens 54 transforms the original light beams OLB into parallel light beams PLB, parallel light beams of a specific light wavelength are shaped after passing a beam shaping device 50, shaped beams SB are projected. A square lighting pattern 58 is shown as an example in FIG. 7.

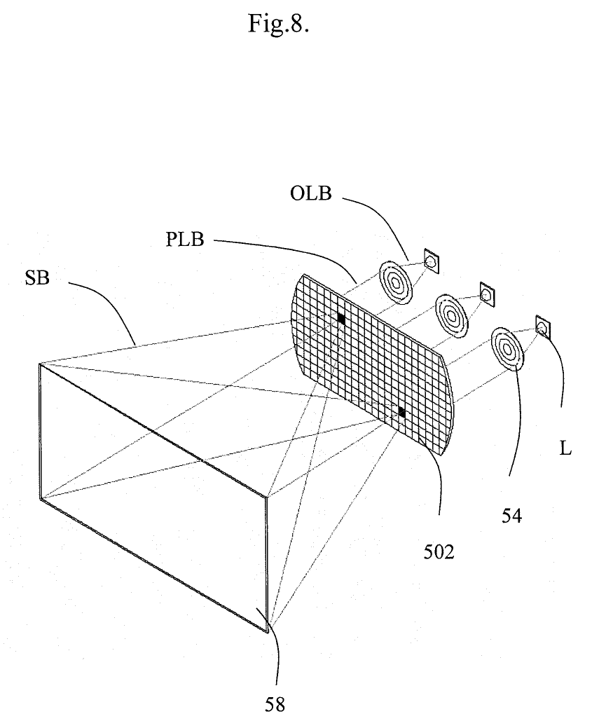

FIG. 8 shows a second projection system using the beam shaping device according to the present invention.

Multiple light sources L and multiple collimating lens 54 are used in a system as shown in FIG. 8. Here a larger beam shaping device 502 is shown and more collimating lens 54 and more wide angle light sources are needed to match. The operation theory is the same as described in previous paragraphs.

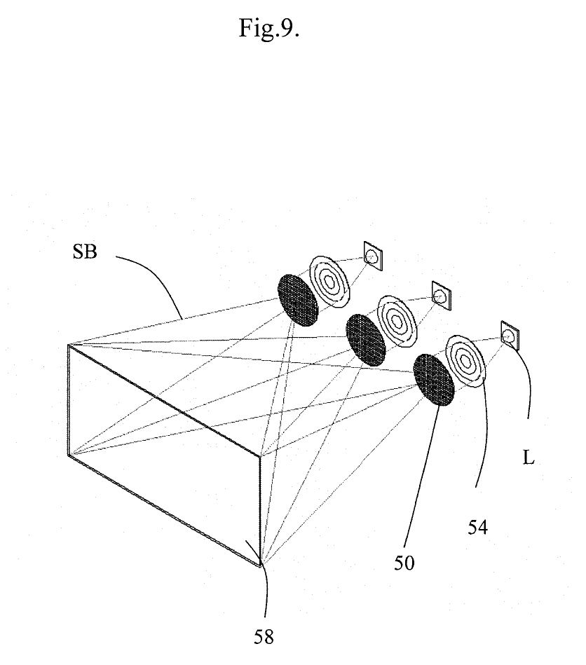

FIG. 9 shows a third projection system using the beam shaping device according to the present invention.

Multiple beam shaping devices 50 are used in FIG. 9. In this design, three beam shaping devices 50 are used, three collimating lens 54 each corresponding one of the three beam shaping devices 50 are used, and three wide angle light sources L each corresponding to one of the collimating lens 54 are used. The operation theory is the same as that described in previous paragraphs.

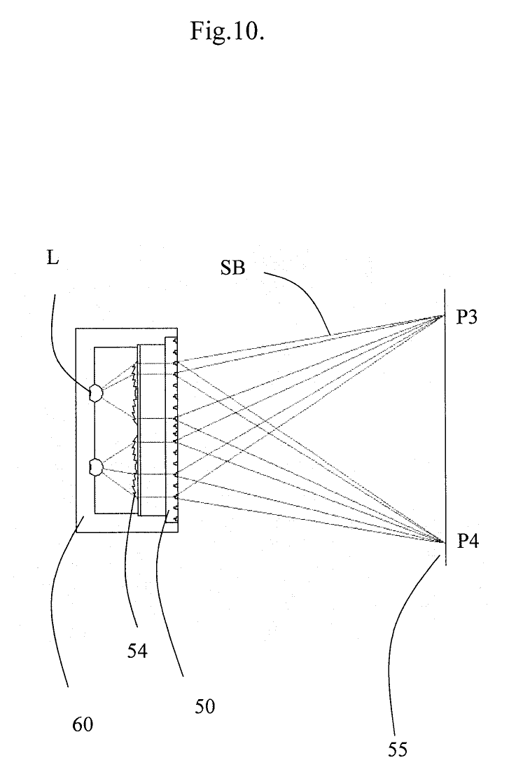

FIG. 10 shows a frame is used to mount elements of a first embodiment of the present invention.

A frame 60 is used for mounting the elements of the projection system. Two wide angle light sources L, two Fresnel lens 54 and one beam shaping device 50 are mounted on the frame 60. Shaped beams SB project spots P3, P4 as a lighting pattern on a screen 55. The operation theory is the same as described in previous paragraphs.

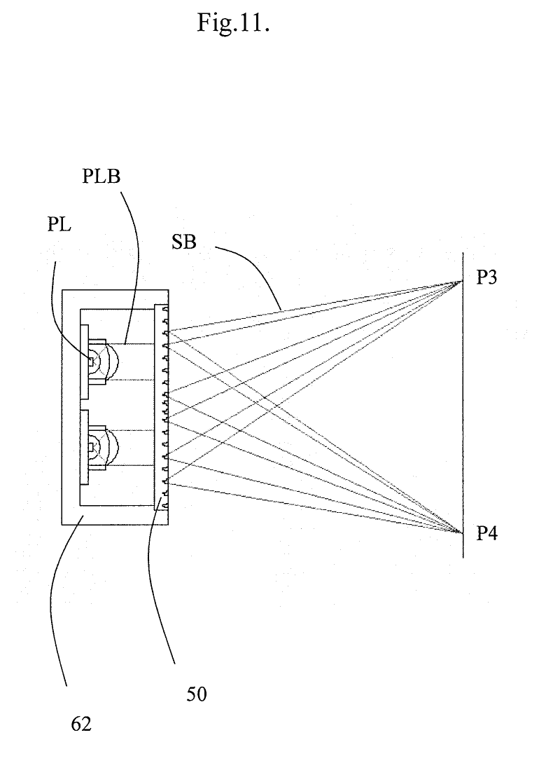

FIG. 11 shows a frame is used to mount elements of a second embodiment of the present invention.

A frame 62 is used to mount the two parallel light sources PL, and the beam shaping device 50 in a predetermined position. Since two parallel light sources PL are used to give parallel light beams PLB as shown in FIG. 11, Fresnel lens is no more needed in this design. The operation theory is the same as described in previous paragraphs.

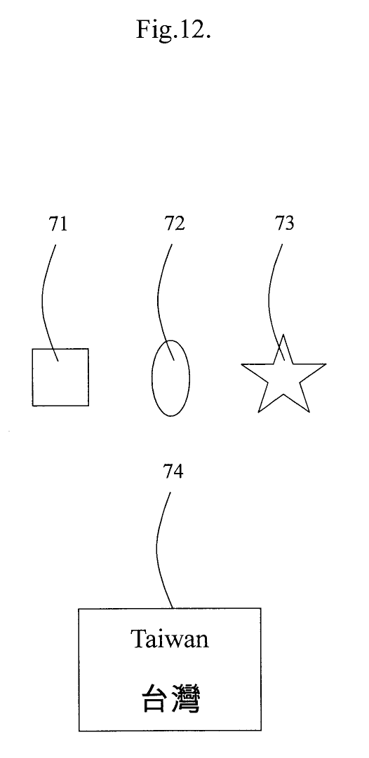

FIG. 12 shows samples of lighting pattern to be projected.

Several lighting patterns are exemplified that can be projected by shaped beams SB as shown in FIG. 12. A square lighting pattern 58 has been shown in FIGS. 7,8, and 9; and points lighting pattern P3, P4 have been shown in FIGS. 10 and 11. However, additional lighting pattern includes but not limited to the shapes of point and square, oval 72, star 73, or characters 74 can be projected by the shaped beams SB.

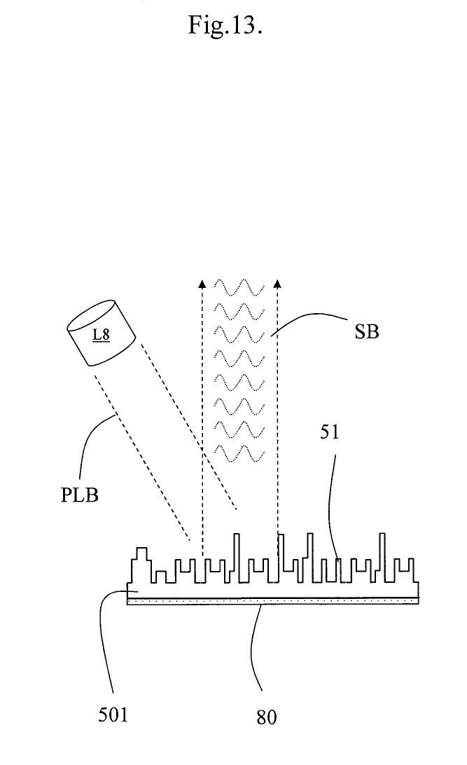

FIG. 13 shows a third embodiment of the beam shaping device according to the present invention.

A reflective type beam shaping device is disclosed in FIG. 13. A reflective coating 80 is configured on bottom side of a beam shaping device 501. A parallel light source L8 gives parallel light beams PLB, the parallel light beams PLB illuminate the reflective beam shaping device 501. Micro-steps 51 cause a first wave diffraction of light beams of a specific light wavelength. After reflection by the reflective coating 80, a second wave diffraction occurs and then shaped beams SB is projected. A column lighting pattern is exemplified to be projected in FIG. 13.

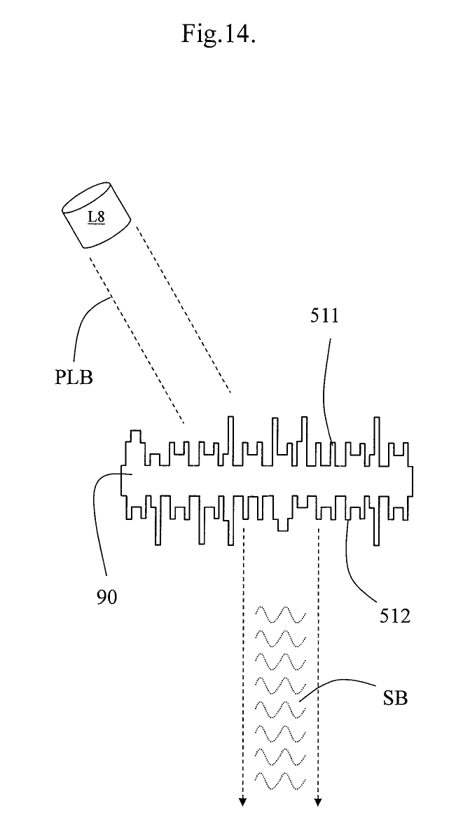

FIG. 14 shows a fourth embodiment of beam shaping device according to the present invention.

A double sided micro-steps beam shaping device is shown in FIG. 14. A double-sided beam shaping device 90 has micro-steps 511 made on top side surface of the substrate 90 and micro-steps 512 made on bottom side surface of the substrate 90. A parallel light source L8 gives parallel light beams PLB which illuminates the double-sided beam shaping device 90. Light beams of a specific light wavelength is first diffracted by the top micro-steps 511 and second diffracted by the bottom micro-steps 512, finally shaped beams SB are projected on bottom side.

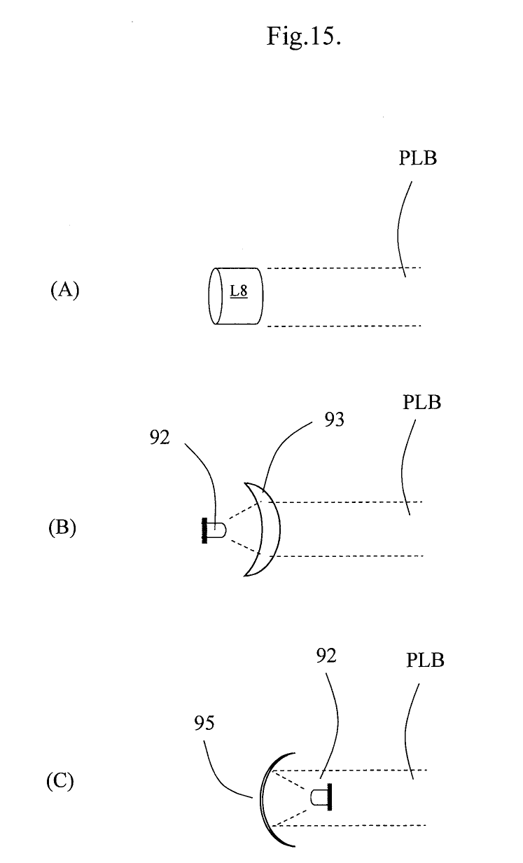

FIG. 15A, 15B, 15C shows various types of a parallel light source.

A parallel light source L8 gives parallel light beams PLB directly is shown in FIG. 15A. However, parallel light beams PLB can also be produced by different combination of elements. FIG. 15B shows a wide angle light source 92 in combination of a piece of convex lens 93 gives parallel light beams PLB. FIG. 15C shows a wide angle light source 92 in combination of a piece of concave mirror 95 also gives parallel light beams PLB.

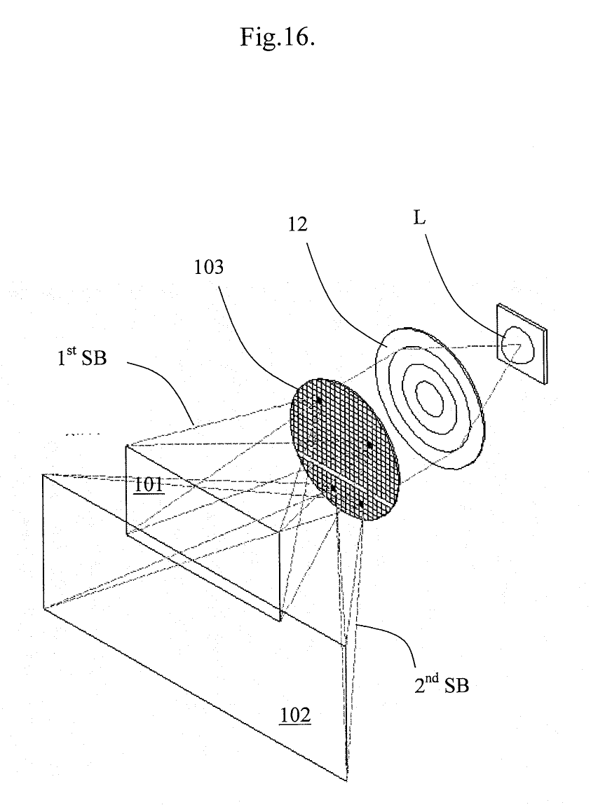

FIG. 16 shows a fifth embodiment of the beam shaping device according to the present invention.

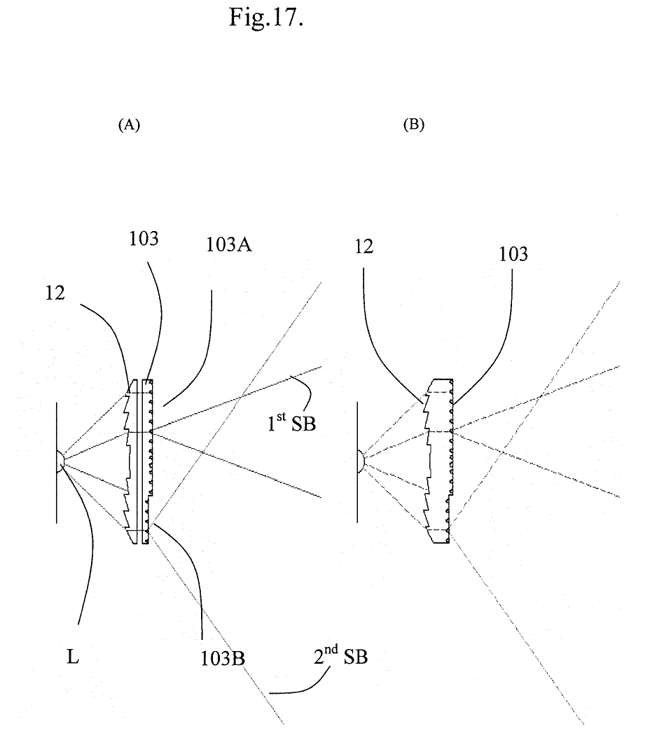

Double projection areas can be made through a designed beam shaping device as shown in FIG. 16. A first projection area or lighting pattern 101 is formed by first shaped beams 1^{st} SB. A second projection area or lighting pattern 102 is formed by second shaped beams 2^{nd} SB. The double projection feature can be obtained by a special design of the beam shaping device 103. FIG. 17A and 17B show two of the designs which give double projection feature.

FIG. 17A shows a section view of the projection system of FIG. 16.

A wide angle light source L giving original light beams OLB which illuminates a Fresnel lens 103 to form parallel light beams PLB is shown in FIG. 17A. The parallel light beams PLB passes through a beam shaping device 103 and then projects onto a screen. A plurality of micro-steps 103A made on a first area of the beam shaping device 103 on right side, response to first light beams having a first light wavelength, to cause a first wave diffraction which produces a first shaped beams 1^{st} SB; and a plurality of micro-steps 103B made on a second area of the beam shaping device 103 on right side, response to second light beams having a second light wavelength to cause wave diffraction which produces a second shaped beams 2^{nd} SB. The plurality of first micro-steps 103A is made in a higher level of the device 103; and the plurality of second micro-steps 103B is made in a lower level on the device 103.

FIG. 17B shows a modified design of the projection system of FIG. 17A.

The Fresnel lens 12 is integrated with the beam shaping device 103 as shown in FIG. 17B. The operation theory is the same as described in previous paragraphs.

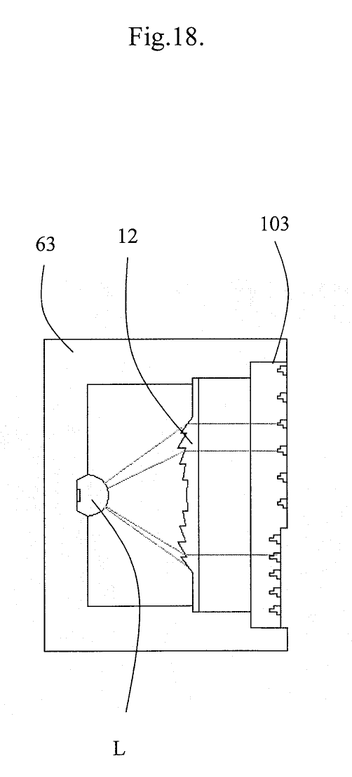

FIG. 18 shows a frame is used to mount the elements of the projection system of FIG. 17A

A frame 63 is used to mount the elements of FIG. 17A. The collimating lens 12 is sandwiched by the light source L and the beam shaping device 103 are mounted on the frame 63 in a predetermined position.

A light emitted diode (LED) is exemplified to be used as one of the wide angle light sources; however a cold cathode fluorescent light (CCFL) bulb also can be used in the present invention as a wide angle light source. Fresnel lens is exemplified to be used as one of the collimating lens, however a traditional spherical lens can also be used. 11. Not only visible lights can be shaped with beam shaping devices as described in previous paragraphs, but also invisible light including but not limited to infrared (IR), near infrared (NIR), ultraviolet (UV), and extreme ultraviolet (EUV) are also can be shaped with the beam shaping device according to the present invention.

While several embodiments have been described by way of example, it will be apparent to those skilled in the art that various modifications may be made without departing from the spirit of the present invention. Such modifications are all within the scope of the present invention, as defined by the appended claims.

What is claimed is:

1. A multi-wavelength beam shaping device, comprising:
a transparent substrate, having a top side and a bottom side;
a plurality of first micro-steps, distributed on said top side; responsive to first light beams of a specific first light wavelength to cause wave diffraction; and
a plurality of second micro-steps, distributed on said top side; responsive to second light beams of a specific second light wavelength to cause wave diffraction.

2. A multi-wavelength beam shaping device as claimed in claim 1, further comprising:
a plurality of third micro-steps, distributed on said top side; responsive to third light beams of a specific light wavelength to cause wave diffraction.

3. A projection system using a beam shaping device of claim 1, further comprising:
a wide angle light source, emitting original light beams.

4. A projection system as claimed in claim 3, further comprising:
a collimating lens, sandwiched in between said wide angle light source and said beam shaping device, for transforming said original light beams into parallel light beams.

5. A projection system as claimed in claim 4, wherein said collimating lens being selected from a group consisted of: spherical lens and Fresnel lens.

6. A projection system as claimed in claim 3, further comprising:
a convex lens, sandwiched in between said wide angle light source and said beam shaping device for transforming said original light beams into parallel light beams.

7. A projection system as claimed in claim 3, further comprising:
a concave mirror, for reflecting said original light beams into parallel light beams.

8. A projection system as claimed in claim 4, wherein said collimating lens being integrated with said beam shaping device.

9. A multi-wavelength beam shaping device as claimed in claim 1, wherein said first light wavelength being selected from a group consisted of: visible light and invisible light.

10. A multi-wavelength beam shaping device as claimed in claim 9, wherein said visible light being selected from a group consist of: red, green and blue.

11. A multi-wavelength beam shaping device as claimed in claim 9, wherein said invisible light being selected from a group consist of: infrared (IR), near infrared (NIR), ultraviolet (UV), and extreme ultraviolet (EUV).

12. A multi-wavelength beam shaping device as claimed in claim 1, wherein said second light wavelength being selected from a group consisted of: visible light and invisible light.

13. A multi-wavelength beam shaping device as claimed in claim 12, wherein said visible light being selected from a group consist of: red, green and blue.

14. A multi-wavelength beam shaping device as claimed in claim 12, wherein said invisible light being selected from a group consist of: infrared (IR), near infrared (NIR), ultraviolet (UV), and extreme ultraviolet (EUV).

15. A multi-wavelength beam shaping device as claimed in claim 2, wherein said third light wavelength being selected from a group consist of: visible light and invisible light.

16. A multi-wavelength beam shaping device as claimed in claim 15, wherein said visible light being selected from a group consist of: red, green and blue.

17. A multi-wavelength beam shaping device as claimed in claim 15, wherein said invisible light being selected from a group consist of: infrared (IR), near infrared (NIR), ultraviolet (UV), and extreme ultraviolet (EV).

18. A projection system using a beam shaping device of claim 1, further comprising:
a parallel light source, emitting parallel light beams to illuminate said beam shaping device.

19. A projection system as claimed in claim 18, wherein a number of said parallel light source being more than one.

20. A projection system as claimed in claim 3, wherein a number of said light source being more than one.

21. A projection system as claimed in claim 4, further comprising:
a frame, fixing said light source, said collimating lens, and said beam shaping device in a pre-determined position.

22. A projection system as claimed in claim 18, further comprising:
a frame, for fixing said parallel light source and said beam shaping device in a pre-determined position.

23. A projection system as claimed in claim 3, wherein said wide angle light source being selected from a group consisted of: a light emitted diode (LED) and a cold cathode fluorescent lamp (CCFL).

24. A projection system, comprising:
at least a multi-wavelength beam shaping device of claim 1; and
at least a parallel light source, to provide parallel light beams illuminating said device of claim 1 to cause wave diffraction for producing a pre-determined lighting pattern.

25. A projection system as claimed in claim 24, wherein said light source being selected from a group consisted of: a light emitted diode (LED) and a cold cathode fluorescent lamp (CCFL).

26. A multi-wavelength beam shaping device as claimed in claim 1, further comprising:
a reflective coating, configured on said bottom side of said transparent substrate.

27. A multi-wavelength beam shaping device as claimed in claim 1, further comprising:
a plurality of third micro-steps, configured on said bottom side of said transparent substrate.

28. A multi-wavelength beam shaping device as claimed in claim 1, wherein a plurality of said first micro-steps is made in a first level on top side of said substrate; and a plurality of said second micro-steps is made in a second level on top side of said substrate.

29. A projection system as claimed in claim 18, wherein said parallel light source is made of a combination of: a wide angle light source and a convex lens.

30. A projection system as claimed in claim 18, wherein said parallel light source is made of a combination of: a wide angle light source and a concave mirror.

31. A projection system using a beam shaping device of claim 28, further comprising:
a parallel light source, for providing parallel beams.

32. A projection system as claimed in claim 31, further comprising:
a frame, for fixing said parallel light source and said beam shaping device in a predetermined position.
